(19) United States
(12) Patent Application Publication
(10) Pub. No.: US 2019/0182841 A1
(43) Pub. Date: Jun. 13, 2019

(54) NETWORK NODES, AND METHODS THEREOF

(71) Applicant: Huawei Technologies Co., Ltd., Shenzhen (CN)

(72) Inventors: Pablo SOLDATI, Kista (SE); Panagiotis FOTIADIS, Kista (SE)

(21) Appl. No.: 16/278,855

(22) Filed: Feb. 19, 2019

Related U.S. Application Data
(63) Continuation of application No. PCT/EP2016/069711, filed on Aug. 19, 2016.

(51) Int. Cl. H04W 72/08; H04W 24/10; H04W 76/14; H04W 72/04

(52) U.S. Cl. CPC H04W 72/08; H04W 24/10; H04W 84/12; H04W 72/0453; H04W 76/14

(57) ABSTRACT

First network node to receive a first Radio Resource Management, RRM, message, a second RRM message, and a third RRM message from a user device, the first RRM message comprising a first RRM measurement report associated with the first network node, the second RRM message comprising a second RRM measurement report associated with a second network node, and the third RRM message comprising a third RRM measurement report associated with a third network node; determine a first control message based on the first RRM message, the second RRM message and the third RRM message, the first control message comprising the third RRM measurement report and a data plane establishment request (DPER) between the user device and the third network node; transmit the first control message to the second network node.

### CROSS-REFERENCE TO RELATED APPLICATIONS

This application is a continuation of International Application No. PCT/EP2016/069711, filed on Aug. 19, 2016, the disclosure of which is hereby incorporated by reference in its entirety.

### TECHNICAL FIELD

The embodiments of the present invention relates to network nodes. Furthermore, the embodiments of the present invention also relates to corresponding methods, a computer program, and a computer program product.

### BACKGROUND

Radio access networks (RAN) are rapidly becoming increasingly denser and heterogeneous as we move towards 5G. In the future, architectures of Single RAN will support HetNet deployments in which an anchor node, e.g., a Long Term Evolution (LTE) eNodeB, provides wide area coverage and signalling connectivity, whilst subtended small cells provide high bandwidth user plane links to users, such as user equipments (UEs). Small cells of different radio access technologies (RATs) and using different spectrum (including unlicensed spectrum) may be attached to the anchor node. In particular, in 3GPP LTE R12 and in R13, different realisations of this concept have or are being standardised. In R12 Dual Connectivity (aka LTE Multiple Stream Aggregation (MSA)) was introduced wherein both macro and small cell nodes belong to LTE, whilst in R13 there are work items to standardise LTE/WLAN interworking, such as LTE-Wi-Fi Aggregation (LWA), and License Assisted Access (LAA).

In LTE Dual Connectivity (DC), a UE maintains two downlink radio links, one to a macro eNB (operating at frequency f1) and one to a pico eNB (at f2). The eNBs are connected by non-ideal backhaul, meaning that packet transmissions incur a delay of tens of ms. Radio resource control (RRC) control signalling is sent only to the macro eNB which means that the UE can move under the coverage of the LTE macro cell without incurring any layer 3 handover events. The uplink user plane of the UE is sent on either the macro link or the pico link, whilst the downlink user plane has the additional option of being split and using both links (link aggregation). The downlink user plane bearer splitting occurs at the Packet Data Convergence Protocol (PDCP) protocol layer such that PDCP Packet Data Units (PDUs) are sent either from the macro eNB or forwarded over the X2 interface to the pico eNB. The pico eNB queues the PDCP PDUs and determines when to schedule their transmissions. Since PDCP PDUs may arrive out-of-sequence at the UE, the PDCP layer there includes reordering functionality. In 3GPP terminology the eNB anchoring the RRC of a user is called the MeNB (Master eNB, the macro cell in our example for the LTE DC UE) and the other eNB is called the SeNB (Secondary eNB, the pico eNB).

For LTE/WLAN interworking, Rel-12 specifications have introduced an Access Network Selection (ANS) mechanism for LTE/WLAN traffic steering. The UE device offloading decision is taken by based on assistance parameters that are provided by the cellular network. In that sense, decision thresholds with respect to signal strength/quality, load, etc. determine the condition to be met for steering traffic from/to WLAN. Additional integration enhancements have been considered in LTE Rel-13. These include fully network-controlled LTE/WLAN traffic steering, aka LTE WLAN Interworking (LWI) or even downlink LTE-WLAN Aggregation (LWA) that allows UEs to concurrently receive data from both Radio Access Technologies (RAT). The LWA design draws many aspects from LTE DC. To improve the capacity of the DL WiFi, the UL WiFi MAC control frames are sent over LTE (encapsulated by the RRC protocol), and no UL user plane is mapped to WiFi. LWA is being standardized with two architectures: Non co-located and Co-located.

In the LWA non co-located architecture, the LTE eNB and Wi-Fi node (this could for example be an access point (AP) or an AP controller) are connected by a non-ideal backhaul. The UE is held in RRC connected mode. By means of the backhaul, WLAN load conditions can be reported to the LTE network, whilst physical layer measurements performed by the UE for both RATs are sent in uplink using the always-on RRC connection. Exploiting such measurements, the LTE base station can select WLAN offloading UE candidates and send them the associated steering command via RRC signalling. It is worth mentioning that the UE's user plane can be also served by the WLAN alone. This is LTE-WLAN interworking (LWI). In LWA, the UE can be configured with a WLAN Secondary Cell (SCell) enabling the concurrent downlink data reception from both RATs. The procedure is still network-controlled; however, it involves different signalling compared to LWI. The user data plane is split at the PDCP layer of the LTE node and the amount of data forwarded over each RAT can be derived based on the LTE/WLAN radio conditions on, node loading, flow control messages, etc. Among others, LWA offers a more stable data connection as the UE can still receive data on the LTE link even if its WLAN connectivity is lost. On the other hand, it increases UE power consumption since the UE essentially has to process data from both links.

In the LWA co-located architecture, the eNB and WLAN device (e.g. AP) are implemented in the same box, or are linked by an ideal backhaul connection (meaning latency much less than 1 ms, for example, a fibre link). The RRC control connection is terminated at the co-located eNB. This is true even if the co-located device is a small cell node and there exists an overlay network made from macro cells. Here one UE exists in LTE DC (with all options described above), and another UE exists in LWA, so that downlink packets can be sent via the pico eNB or the AP, or both (split bearer). The splitting of packets is decided by the so-called PDCP Scheduler, which determines to send PDCP PDUs down one link or the other. In the co-located pico and AP joint scheduling or coordinated/coupled scheduling can give significant performance gains by exploiting variations in the loading of the cells and radio conditions of the users. For example, when the pico load momentarily drops, PDCP PDUs can be sent over the pico air interface in addition to over WiFi. For example, if a user suffers sudden interference in the unlicensed band, its traffic can be routed onto the pico cell. To support this joint scheduling it is important to know the radio conditions (such as communication path loss, interference level) in both pico and AP for LWA users. Since, there is preferably no WLAN uplink to carry uplink management information (or user plane data), this information is obtained using RRC signalling, direct to the pico cell since RRC is terminated there.

The existing conventional solution has the following weaknesses for the co-located deployment of small cells with macro overlay. Wide-area mobility with no handover events within the coverage of a macro cell is not possible. Furthermore, when the UE moves from co-located LWA to either of the other two modes of operation the RRC connection must be moved (L3 handover). This incurs a risk of a call-drop when the handover fails, which is not true for when the UE is switched between LTE DC and LWA non co-located, since the RRC is held fixed in this instance and there is no handover. Instead a simple RRC reconfiguration (without mobility control information) is incurred which should be very reliable (so low risk of call drop) unless the UE lies on the border between one macro cell and another (on the same carrier frequency). Note that the handover we describe is an inter-frequency handover which is typically more reliable than an intra-frequency coverage handover—the biggest risk is on a pico to macro handover, but is still expected to be less robust than the simple RRC reconfiguration.

### SUMMARY

An objective of embodiments of the disclosure is to provide a solution which mitigates or solves the drawbacks and problems of conventional solutions.

Another objective of embodiments of the disclosure is to provide a solution for improved mobility in wireless communication systems.

An “or” in this description and the corresponding claims is to be understood as a mathematical OR which covers “and” and “or”, and is not to be understand as an XOR (exclusive OR).

The indefinite article “a” in this disclosure and claims is not limited to “one” and can also be understood as “one or more”, i.e., plural.

The above objectives are solved by the subject matter of the independent claims. Further advantageous implementation forms of the embodiments of the present invention can be found in the dependent claims.

According to a first aspect of the disclosure, the above mentioned and other objectives are achieved with a first network node for a wireless communication system, the first network node comprising
a transceiver configured to

receive a first Radio Resource Management, RRM, message, a second RRM message, and a third RRM message from a user device, the first RRM message comprising a first RRM measurement report associated with the first network node, the second RRM message comprising a second RRM measurement report associated with a second network node, and the third RRM message comprising a third RRM measurement report associated with a third network node;
a processor configured to

determine a first control message based on the first RRM message, the second RRM message and the third RRM message, the first control message comprising the third RRM measurement report and a data plane establishment request between the user device and the third network node;
wherein the transceiver is configured to

transmit the first control message to the second network node.

The first RRM, message, the second RRM message, and the third RRM message are in an alternative transmitted in separate messages from the same user device. In another alternative, the first RRM, message, the second RRM message, and the third RRM message are transmitted in one or two messages from the user device. In this respect the RRM messages may be encapsulated in the message(s) from the user device.

In an implementation form according to the first aspect, the first control message may further comprise an identity of the third network node and a request to determine whether a communication path exist between the second network node and the third network node.

The first network node according to the first aspect enables seemingly continuous connectivity under mobility of the user device within the coverage area of a group of secondary network nodes that can provide wireless connectivity and services to the user device, wherein not all secondary network nodes share a communication interface with the network node providing control plane information to the user device. Additionally, the first network node according to the first aspect enables to support three or more simultaneous data plane connections with the user device. The data plane connection could be provided over a combination of licensed and unlicensed frequency spectrum bands. Additionally, the first network node according to the first aspect enables to efficiently exchange RRM messages from the user device associated licensed and unlicensed frequency spectrum and different network nodes.

In a first implementation form of a first network node according to the first aspect, the transceiver is configured to

receive a fourth control message from the second network node, the fourth control message comprising a data plane establishment acknowledgment associated with the data plane establishment request,

receive a first sequence of data packets addressed for the user device from a core network,

forward a second sequence of data packets to the second network node in response to the reception of the fourth control message (and of the first sequence of data packets), the second sequence of data packets comprising at least a part of the first sequence of data packets.

The first implementation form enables the first network node to determine whether a new data plane connection can be provided for the user device with a third network node with minimum signaling overhead. Additionally, the first network node is enabled to efficiently configure and optimize the amount of data packets to be transmitted to the user device via the third network node and forward said data packets through the second network node.

In a second implementation form of a first network node according to the first implementation form of the first aspect, wherein the processor is configured to

determine a fifth control message comprising an instruction to establish a data plane connection with the third network node,
wherein the transceiver is configured to

transmit the fifth control message to the user device after reception of the fourth control message.

In an implementation form according to the second implementation form of the first aspect, the instruction further comprises at least one of: an identity of the third network node; a frequency carrier or a RAT to be used for establishing the data plane connection to the third network node; and a data plane connection release command associated to an existing data plane connection.

The second implementation form provides a rapid and efficient solution to establish a new data plane connection for the user device, possibly by using a different RAT, while keeping the pre-existing data plane connections with other network nodes and control plane connection anchored at the same network node.

In a third implementation form of a first network node according to the first or second implementation form of the first aspect or to the first aspect as such, the data plane establishment request further comprises a status report request addressed to the third network node for at least one of: a request of the available frequency bands or frequency carriers or Radio Access Technologies, RATs at the third network node.

In an alternative third implementation form of a first network node according to the first or second implementation form of the first aspect, the data plane establishment request further comprises a status report request addressed to the third network node for at least one of: a request of available frequency bands or frequency carriers or RATs; a request of traffic load report associated to the available frequency bands or frequency carriers or RATs; a request of interference level report in the available frequency bands or RATs; a request of recommended frequency bands or frequency carriers or RATs to establish a data plane connection with the user device; a request of the sustainable traffic load for the requested data plane connection; a request of the average amount of radio resource available for the requested data plane connection; and a request of the expected quality of service (QoS) or quality of experience (QoE) for the requested data plane connection at the third network node.

The third implementation form has an advantage of enabling the first network node to determine whether the third network node has sufficient resources to provide the required data plane connection for the user device. Additionally, the third implementation form enables the first network node to determine whether to establish a data plane connection between the user device and the third network node based on estimates of the QoS or QoE that the third network node can provide to the user device, as well as on QoS or QoE requirements from the user device.

In a fourth implementation form of a first network node according to the first, second or third implementation form of the first aspect or to the first aspect as such, the first control message further comprises a data plane establishment instruction comprising a data split ratio of the second sequence of data packets into a third sequence of data packets addressed for the third network node, wherein the third sequence of data of packets comprises at least a part of the second sequence of data packets.

The data split ratio may further indicate that data packets that are not comprises in the third sequence of data packets should be comprises in the second sequence of data packets. The data split ratio may further indicate that the third sequence of data packets comprises the entire second sequence of data packets.

In an alternative fourth implementation form of a first network node according to the first or second implementation form of the first aspect, the first control message further comprises a data plane establishment instruction comprising at least one of: a data split ratio of the second sequence of data packets into a third sequence of data packets addressed for the third network node, wherein the third sequence of data of packets comprises at least a part of the second sequence of data packets; an instruction addressed to the second network node to further split the second sequence of data packets based on the second RRM measurement report and the third RRM measurement report; an instruction addressed to the second network node to forward all data packets of the second sequence of data packets and remaining data packets in a buffer addressed for user device to the third network node; a minimum allocation of radio resources at the third network node to support the data plane connection; and a preferred RAT to establish the requested data plane connection.

The fourth implementation form has an advantage to enable the first network node to control and optimize the data plane split for both the second network and the third network node, or for only one network node. Further, the fourth implementation form also has the advantage of enabling an efficient packet delivery from multiple data plane connection between the user device and one or more network nodes. Additionally, this implementation form has the advantage to enable the first network node to control and optimize the amount of radio resources to use for multiple data plane connections between different network nodes and the user device in order to provide the QoS or QoE required by the user device.

In an implementation form of a first network node according to any of the first to the fourth implementation form of the first aspect, the data plane establishment acknowledgment comprises a status report request response associated to the third network node for at least one of: available frequency bands or frequency carriers or RATs, and wherein the first control message further comprises a data plane establishment instruction comprising a preferred RAT to establish the requested data plane connection at the third network node.

According to a second aspect of the disclosure, the above mentioned and other objectives are achieved with a second network node for a wireless communication system, the second network node comprising
a transceiver configured to

receive a first control message from a first network node, the first control message comprising a data plane establishment request between a user device and a third network node, and a third RRM measurement report associated with the user device and the third network node;
a processor configured to

determine a second control message comprising the data plane establishment request and the third RRM measurement report if a communication interface exists between the second network node and the third network node; wherein the transceiver is configured to

transmit the second control message to the third network node.

An advantage of the second network node according to the second aspect is to provide a fast and efficient way to determine whether a new data plane communication path can be established with the user device and a third network node via a second network node, wherein the third network node does not have a communication interface (e.g., the X2 interface in a LTE system) with a first network node providing control plane information to the user device.

In a first implementation form of a second network node according to the second aspect, the data plane establishment request further comprises a status report request addressed to the third network node for at least one of: a request of the available frequency bands or frequency carriers or RATs of the third network node.

In an alternative first implementation form of a second network node according to the second aspect, the data plane establishment request further comprises a status report request addressed to the third network node for at least one of: a request of available frequency bands or frequency carriers or RATs; a request of traffic load report associated to the available frequency bands or frequency carriers or RATs; a request of interference level report in the available frequency bands or RATs; a request of recommended frequency bands or frequency carriers or RATs to establish a data plane connection with the user device; a request of the sustainable traffic load for the requested data plane connection; a request of the average amount of radio resource available for the requested data plane connection; and a request of the expected QoS or QoE for the requested data plane connection.

The first implementation form has an advantage of enabling the second network node to inquire the third network node whether it has sufficient resources to provide the required data plane connection for the user device. Additionally, the first implementation form enables the second network node inquire whether the third network node can establish a data plane connection with the user device with the required QoS or QoE.

In a second implementation form of a second network node according to the first implementation form of the second aspect or to the second aspect as such, the transceiver is configured to

receive a third control message from the third network node, the third control message comprising a data plane establishment acknowledgment associated with the data plane establishment request,
wherein the processor is configured to

determine a fourth control message comprising the data plane establishment acknowledgment in response to the reception of the third control message, wherein the transceiver is configured to

transmit the fourth control message to the first network node.

The second implementation form has the advantage of providing fast feedback information to the first network node comprising an acknowledgement of whether a communication path exists between the second network node and the third network node as well as whether the required data plane connection to the user device can be provided. Thereby the second implementation form has the advantage of reducing the data packet delivery time, i.e., latency, when the data plane connection for the user device is established with the third network node. Furthermore, the second implementation form has the advantage of reducing the signaling overhead required to establish the required data plane connection.

In a third implementation form of a second network node according to the second implementation form of the second aspect, the data plane establishment acknowledgment comprises a status report request response associated to the third network node for at least one of: available frequency bands or frequency carriers or RATs at the third network node.

In an alternative third implementation form of a second network node according to the second implementation form of the second aspect, the data plane establishment acknowledgment comprises a status report request response associated to the third network node for at least one of: available frequency bands or frequency carriers or RATs; a traffic load report associated to the available frequency bands or frequency carriers or RATs; an interference level report in the available frequency bands or RATs; a report of recommended frequency bands or frequency carriers or RATs to establish a data plane connection with the user device; a report of the sustainable traffic load for the requested data plane connection; a report of the average amount of radio resource available for the requested data plane connection; and a report of the expected QoS or QoE for the requested data plane connection.

The third implementation form has an advantage of enabling the third network node to report to the first network node what radio resources, RAT, QoS and QoE can be provided for the required data plane connection for the user device. Furthermore, third implementation form has an advantage to enable the third network node to report to the first network node a list of recommended radio resources to establish the required data plane connection, as well as to report traffic load information so as to optimize the amount of data traffic supported for the required data plane connection.

In a fourth implementation form of a second network node according to the second or third implementation form of the second aspect, the transceiver is configured to

receive a second sequence of data packets addressed for the user device from the first network node in response to the transmission of the fourth control message,

forward a third sequence of data packets to the third network node, the third sequence of data packets comprising at least a part of the second sequence of data packets.

The fourth implementation form has the advantage of enabling efficient data forwarding from the second network node to the third network node associated to the requested data plane connection between the third network node and the user device.

In an implementation form of a second network node according to the fourth implementation form of the second aspect, the first control message further comprises a data plane establishment instruction comprising a data split ratio of the second sequence of data packets into a third sequence of data packets addressed for the third network node, wherein the third sequence of data of packets comprises at least a part of the second sequence of data packets,
wherein the processor is configured to

determine the third sequence of data of packets based on the data split ratio.

This implementation form of a second network node according to the fourth implementation form of the second aspect has the advantage to enable the second network node to control and optimize the flow of data packets forwarded to the third network node based on a data split ratio instruction associated to the second sequence of data packets.

In an implementation form of a second network node according to the fourth implementation form of the second aspect, the first control message further comprises a data plane establishment instruction comprising an instruction addressed to the second network node to further split the second sequence of data packets based on the second RRM measurement report and the third RRM measurement report,
wherein the processor is configured to

determine the third sequence of data of packets based on the second RRM measurement report and the third RRM measurement report.

This implementation form of a second network node according to the fourth implementation form of the second aspect has the advantage to enable the second network node to further control and optimize the flow of data packets forwarded to the third network node based on the link quality between the user device and the second network node and the third network node.

In an implementation form of a second network node according to the fourth implementation form of the second aspect, the first control message further comprises a data plane establishment instruction indicating a minimum allocation of radio resources at the third network node to support the data plane connection, or a preferred RAT to establish the requested data plane connection; and

wherein the processor is further configured to

determine the second control message to further comprise the data plane establishment instruction.

This implementation form of a second network node according to the fourth implementation form of the second aspect has the advantage to configure a minimum amount of radio resources at the third network node to be provided for the required data plane connection.

In a fifth implementation form of a second network node according to the fourth implementation form of the second aspect, the first control message further comprises a data plane establishment instruction comprising an instruction for the second network node to forward all data packets of the second sequence of data packets and remaining data packets in a buffer addressed for user device to the third network node,
the transceiver is configured to

forward all data packets of the second sequence of data packets and remaining data packets in a buffer addressed for user device to the third network node,

release the data plane connection with the user device after having forwarded all data packets of the second sequence of data packets and of the buffer.

The fifth implementation form has an advantage of reducing the data packet delivery time, i.e., latency, when the data plane connection for the user device is moved from the second network node to the third network node.

According to a third aspect of the disclosure, the above mentioned and other objectives are achieved with a third network node_for a wireless communication system, the third network node comprising
a transceiver configured to

receive a second control message from a second network node, the second control message comprising a data plane establishment request between a user device and the third network node, and a third RRM measurement report associated with the user device and the third network node;

establish a data plane connection to the user device in response to the reception of the second control message based on the third RRM measurement report.

The advantage of the third network node according to the third aspect is to provide a fast and efficient way to determine whether a new data plane communication path can be established between the user device and a third network node via a second network node, wherein the third network node does not have a communication interface (e.g., the X2 interface in a LTE system) with a first network node providing control plane information to the user device.

In a first implementation form of a third network node according to the third aspect, the third network node comprises a processor configured to

determine a third control message comprising a data plane establishment acknowledgment after the establishment of the data plane connection to the user device, wherein the transceiver is configured to

transmit the third control message to the second control node.

The first implementation form has an advantage of providing fast feedback information to the first network node comprising an acknowledgement of whether the required data plane connection to the user device can be provided, thereby reducing the data packet delivery time, i.e., latency, when the data plane connection for the user device is established with the third network node.

In a second implementation form of a third network node according to the first implementation form of the third aspect, the data plane establishment request further comprises a status report request addressed to the third network node for at least one of: a request of available frequency bands or frequency carriers or RATs at the third network node, and
wherein the data plane establishment acknowledgment further comprises a status report request response for at least one of: available frequency bands or frequency carriers or RATs at the third network node.

In an alternative second implementation form of a third network node according to the first implementation form of the third aspect, the data plane establishment request further comprises a status report request addressed to the third network node for at least one of: a request of the available frequency bands or frequency carriers or RATs at the third network node; a request of traffic load report associated to the available frequency bands or frequency carriers or RATs; a request of interference level report in available frequency bands or the RATs; a request of recommended frequency bands or frequency carriers or RATs to establish a data plane connection with the user device; a request of the sustainable traffic load for the requested data plane connection; a request of the average amount of radio resource available for the requested data plane connection; and a request of the expected QoS or QoE for the requested data plane connection; and
wherein the status report request response further comprises at least one of: available frequency bands or frequency carriers or RATs at the third network node; a report of traffic load report associated to the available frequency bands or frequency carriers or RATs; a report of interference level report in the available frequency bands or RATs; a report of recommended frequency bands or frequency carriers or RATs to establish a data plane connection with the user device; a report of the sustainable traffic load for the requested data plane connection; a report of the average amount of radio resource available for the requested data plane connection; and a report of the expected QoS or QoE for the requested data plane connection.

The second implementation form has an advantage of enabling efficient control information exchange between the first network node and the third network node essential to determine whether the required data plane connection with the user device can be established with the required radio resource, quality of service and quality of experience.

In a third implementation form of a third network node according to the first or second implementation form of the third aspect, the transceiver is configured to

receive a third sequence of data packets from the second network node in response to the transmission of the data plane establishment acknowledgment,

transmit the third sequence of data packets to the user device via the established data plane connection.

The third implementation form has an advantage of reducing the data packet delivery time, i.e., latency, when the data plane connection for the user device is established with the third network node.

In an implementation form of a third network node according to the third aspect as such, the second control message further comprises a data plane establishment instruction between the user device and the third network node, and
wherein the processor is configured to

establish a data plane connection to the user device based on data plane establishment instruction.

In an implementation form of a third network node according to the third aspect as such, the data plane establishment instruction comprises at least one of: a minimum allocation of radio resources at the third network node to support the requested data plane connection; and a preferred RAT to establish the requested data plane connection.

According to a fourth aspect of the disclosure, the above mentioned and other objectives are achieved with a method comprising

receiving a first Radio Resource Management, RRM, message, a second RRM message, and a third RRM message from a user device, the first RRM message comprising a first RRM measurement report associated with the first network node, the second RRM message comprising a second RRM measurement report associated with a second network node, and the third RRM message comprising a third RRM measurement report associated with a third network node;

determining a first control message based on the first RRM message, the second RRM message and the third RRM message, the first control message comprising the third RRM measurement report and a data plane establishment request between the user device and the third network node;

transmitting the first control message to the second network node.

In an implementation form of the method according to the fourth aspect, the first control message may further comprise an identity of the third network node and a request to determine whether a communication path exist between the second network node and the third network node.

In a first implementation form of a method according to the fourth aspect, the method comprises

receiving a fourth control message from the second network node, the fourth control message comprising a data plane establishment acknowledgment associated with the data plane establishment request,

receiving a first sequence of data packets addressed for the user device from a core network,

forwarding a second sequence of data packets to the second network node in response to the reception of the fourth control message (and of the first sequence of data packets), the second sequence of data packets comprising at least a part of the first sequence of data packets.

In a second implementation form of a method according to the first implementation form of the fourth aspect, the method comprises

determining a fifth control message comprising an instruction to establish a data plane connection with the third network node,

transmitting the fifth control message to the user device after reception of the fourth control message.

In an implementation form according to the second implementation form of the fourth aspect, the instruction further comprises at least one of: an identity of the third network node; a frequency carrier or a RAT to be used for establishing the data plane connection to the third network node; and a data plane connection release command associated to an existing data plane connection.

In a third implementation form of a method according to the first or second implementation form of the fourth aspect or to the fourth aspect as such, the data plane establishment request further comprises a status report request addressed to the third network node for at least one of: a request of the available frequency bands or frequency carriers or Radio Access Technologies, RATs at the third network node.

In an alternative third implementation form of a method according to the first or second implementation form of the fourth aspect, the data plane establishment request further comprises a status report request addressed to the third network node for at least one of: a request of available frequency bands or frequency carriers or RATs; a request of traffic load report associated to the available frequency bands or frequency carriers or RATs; a request of interference level report in the available frequency bands or RATs; a request of recommended frequency bands or frequency carriers or RATs to establish a data plane connection with the user device; a request of the sustainable traffic load for the requested data plane connection; a request of the average amount of radio resource available for the requested data plane connection; and a request of the expected QoS or QoE for the requested data plane connection at the third network node.

In a fourth implementation form of a method according to the first, second or third implementation form of the fourth aspect or to the fourth aspect as such, the first control message further comprises a data plane establishment instruction comprising a data split ratio of the second sequence of data packets into a third sequence of data packets addressed for the third network node, wherein the third sequence of data of packets comprises at least a part of the second sequence of data packets.

The data split ratio may further indicate that data packets that are not comprised in the third sequence of data packets should be comprised in the second sequence of data packets. The data split ratio may further indicate that the third sequence of data packets comprises the entire second sequence of data packets.

In an alternative fourth implementation form of a method according to the first or second implementation form of the fourth aspect, the first control message further comprises a data plane establishment instruction comprising at least one of: a data split ratio of the second sequence of data packets into a third sequence of data packets addressed for the third network node, wherein the third sequence of data of packets comprises at least a part of the second sequence of data packets; an instruction addressed to the second network node to further split the second sequence of data packets based on the second RRM measurement report and the third RRM measurement report; an instruction addressed to the second network node to forward all data packets of the second sequence of data packets and remaining data packets in a buffer addressed for user device to the third network node; a minimum allocation of radio resources at the third network node to support the data plane connection; and a preferred RAT to establish the requested data plane connection.

In an implementation form of a method according to any of the first to the fourth implementation form of the fourth aspect, the data plane establishment acknowledgment comprises a status report request response associated to the third network node for at least one of: available frequency bands or frequency carriers or RATs, and wherein the first control message further comprises a data plane establishment instruction comprising a preferred RAT to establish the requested data plane connection at the third network node.

According to a fifth aspect of the disclosure, the above mentioned and other objectives are achieved with a method comprising

receiving a first control message from a first network node, the first control message comprising a data plane establishment request between a user device and a third network node, and a third RRM measurement report associated with the user device and the third network node;

determining a second control message comprising the data plane establishment request and the third RRM measurement report if a communication interface exists between the second network node and the third network node;

transmitting the second control message to the third network node.

In a first implementation form of a method according to the fifth aspect, the data plane establishment request further comprises a status report request addressed to the third network node for at least one of: a request of the available frequency bands or frequency carriers or RATs of the third network node.

In an alternative first implementation form of a method according to the fifth aspect, the data plane establishment request further comprises a status report request addressed to the third network node for at least one of: a request of available frequency bands or frequency carriers or RATs; a request of traffic load report associated to the available frequency bands or frequency carriers or RATs; a request of interference level report in the available frequency bands or RATs; a request of recommended frequency bands or frequency carriers or RATs to establish a data plane connection with the user device; a request of the sustainable traffic load for the requested data plane connection; a request of the average amount of radio resource available for the requested data plane connection; and a request of the expected QoS or QoE for the requested data plane connection.

In a second implementation form of a method according to the first implementation form of the fifth aspect or to the fifth aspect as such, the method comprising

receiving a third control message from the third network node, the third control message comprising a data plane establishment acknowledgment associated with the data plane establishment request,

determining a fourth control message comprising the data plane establishment acknowledgment in response to the reception of the third control message,

transmitting the fourth control message to the first network node.

In a third implementation form of a method according to the second implementation form of the fifth aspect, the data plane establishment acknowledgment comprises a status report request response associated to the third network node for at least one of: available frequency bands or frequency carriers or RATs at the third network node.

In an alternative third implementation form of a method according to the second implementation form of the fifth aspect, the data plane establishment acknowledgment comprises a status report request response associated to the third network node for at least one of: available frequency bands or frequency carriers or RATs; a traffic load report associated to the available frequency bands or frequency carriers or RATs; an interference level report in the available frequency bands or RATs; a report of recommended frequency bands or frequency carriers or RATs to establish a data plane connection with the user device; a report of the sustainable traffic load for the requested data plane connection; a report of the average amount of radio resource available for the requested data plane connection; and a report of the expected QoS or QoE for the requested data plane connection.

In a fourth implementation form of a method according to the second or third implementation form of the fifth aspect, the method comprising

receiving a second sequence of data packets addressed for the user device from the first network node in response to the transmission of the fourth control message,

forwarding a third sequence of data packets to the third network node, the third sequence of data packets comprising at least a part of the second sequence of data packets.

In an implementation form of a method according to the fourth implementation form of the fifth aspect, the first control message further comprises a data plane establishment instruction comprising a data split ratio of the second sequence of data packets into a third sequence of data packets addressed for the third network node, wherein the third sequence of data of packets comprises at least a part of the second sequence of data packets, the method comprising

determining the third sequence of data of packets based on the data split ratio.

In an implementation form of a method according to the fourth implementation form of the fifth aspect, the first control message further comprises a data plane establishment instruction comprising an instruction addressed to the second network node to further split the second sequence of data packets based on the second RRM measurement report and the third RRM measurement report, the method comprising

determining the third sequence of data of packets based on the second RRM measurement report and the third RRM measurement report.

In an implementation form of a method according to the fourth implementation form of the fifth aspect, the first control message further comprises a data plane establishment instruction indicating a minimum allocation of radio resources at the third network node to support the data plane connection, or a preferred RAT to establish the requested data plane connection; the method comprising

determining the second control message to further comprise the data plane establishment instruction.

In a fifth implementation form of a method according to the fourth implementation form of the fifth aspect, the first control message further comprises a data plane establishment instruction comprising an instruction for the second network node to forward all data packets of the second sequence of data packets and remaining data packets in a buffer addressed for user device to the third network node, the method comprising

forwarding all data packets of the second sequence of data packets and remaining data packets in a buffer addressed for user device to the third network node,

releasing the data plane connection with the user device after having forwarded all data packets of the second sequence of data packets and of the buffer.

According to a sixth aspect of the disclosure, the above mentioned and other objectives are achieved with a method comprising

receiving a second control message from a second network node, the second control message comprising a data plane establishment request between a user device and the third network node, and a third RRM measurement report associated with the user device and the third network node;

establishing a data plane connection to the user device in response to the reception of the second control message based on the third RRM measurement report.

In a first implementation form of a method according to the sixth aspect, the method comprises

determining a third control message comprising a data plane establishment acknowledgment after the establishment of the data plane connection to the user device,

transmitting the third control message to the second control node.

In a second implementation form of a method according to the first implementation form of the sixth aspect, the data plane establishment request further comprises a status report request addressed to the third network node for at least one of: a request of available frequency bands or frequency carriers or RATs at the third network node, and
wherein the data plane establishment acknowledgment further comprises a status report request response for at least one of: available frequency bands or frequency carriers or RATs at the third network node.

In an alternative second implementation form of a method according to the first implementation form of the sixth aspect, the data plane establishment request further comprises a status report request addressed to the third network node for at least one of: a request of the available frequency bands or frequency carriers or RATs at the third network node; a request of traffic load report associated to the available frequency bands or frequency carriers or RATs; a request of interference level report in available frequency bands or the RATs; a request of recommended frequency bands or frequency carriers or RATs to establish a data plane connection with the user device; a request of the sustainable traffic load for the requested data plane connection; a request of the average amount of radio resource available for the requested data plane connection; and a request of the expected QoS or QoE for the requested data plane connection; and
wherein the status report request response further comprises at least one of: available frequency bands or frequency carriers or RATs at the third network node; a report of traffic load report associated to the available frequency bands or frequency carriers or RATs; a report of interference level report in the available frequency bands or RATs; a report of recommended frequency bands or frequency carriers or RATs to establish a data plane connection with the user device; a report of the sustainable traffic load for the requested data plane connection; a report of the average amount of radio resource available for the requested data plane connection; and a report of the expected QoS or QoE for the requested data plane connection.

In a third implementation form of a method according to the first or second implementation form of the sixth aspect, the method comprises

receiving a third sequence of data packets from the second network node in response to the transmission of the data plane establishment acknowledgment,

transmitting the third sequence of data packets to the user device via the established data plane connection.

In an implementation form of a method according to the sixth aspect as such, the second control message further comprises a data plane establishment instruction between the user device and the third network node, the method comprises

establishing a data plane connection to the user device based on data plane establishment instruction.

In an implementation form of a method according to the sixth aspect as such, the data plane establishment instruction comprises at least one of: a minimum allocation of radio resources at the third network node to support the requested data plane connection; and a preferred RAT to establish the requested data plane connection.

Embodiments of the present invention also relates to a computer program, characterized in code means, which when run by processing means causes said processing means to execute any method according to the embodiments of the present invention. Further, the disclosure also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further applications and advantages of the embodiments of the present invention will be apparent from the following detailed description.

### BRIEF DESCRIPTION OF THE DRAWINGS

The appended drawings are intended to clarify and explain different embodiments of the present invention, in which:

FIG. 1 shows a first network node according to an embodiment of the disclosure.

FIG. 2 shows a flow chart of a method according to an embodiment of the disclosure.

FIG. 3 shows a second network node according to an embodiment of the disclosure.

FIG. 4 shows a flow chart of a method according to an embodiment of the disclosure.

FIG. 5 shows a third network node according to an embodiment of the disclosure.

FIG. 6 shows a flow chart of a method according to an embodiment of the disclosure.

FIG. 7 illustrates interaction and interworking between a user device, a first network node, a second network node, and a third network node in a wireless communication system according to embodiments of the disclosure.

FIG. 8 illustrates different architectures for data plane split according to embodiments of the disclosure.

### DETAILED DESCRIPTION

Embodiments of the disclosure disclose a solution for splitting a data bearer (e.g., a sequence of data packets) associated to a user device and forwarding the corresponding data from a first network node providing a mobility anchor (e.g. a network control node) toward two or more other network nodes providing data plane connection, wherein not all of said other network nodes share a communication path (e.g. an interface) with the first network node. Furthermore, embodiments of the disclosure disclose a solution for reconfiguring one or more data plane links associated to a user device between two or more of said other network nodes, based on the resource availability at said other network nodes and the user device's bearer requirements, such as quality of service, quality of experience, etc. Furthermore, embodiments of the disclosure disclose a solution to select (either at the first network node or at said other second network nodes) radio resources and radio access technology that said other second network nodes configured to provide an additional data plane connection to the user device should allocate to serve the user device.

FIG. 1 shows a first network node 100 according to an embodiment of the disclosure. The first network node 100 comprises a transceiver 102 and a processor 104 which are communicably coupled to each other with communication means 110 known in the art. Further, the first network node 100 also comprises an antenna 106 and/or a modem 108 coupled with the transceiver 102. The antenna 106 is configured for wireless communications whilst the modem 108 is configured for wired communications via a wired communication interface 112, e.g. a backhaul link.

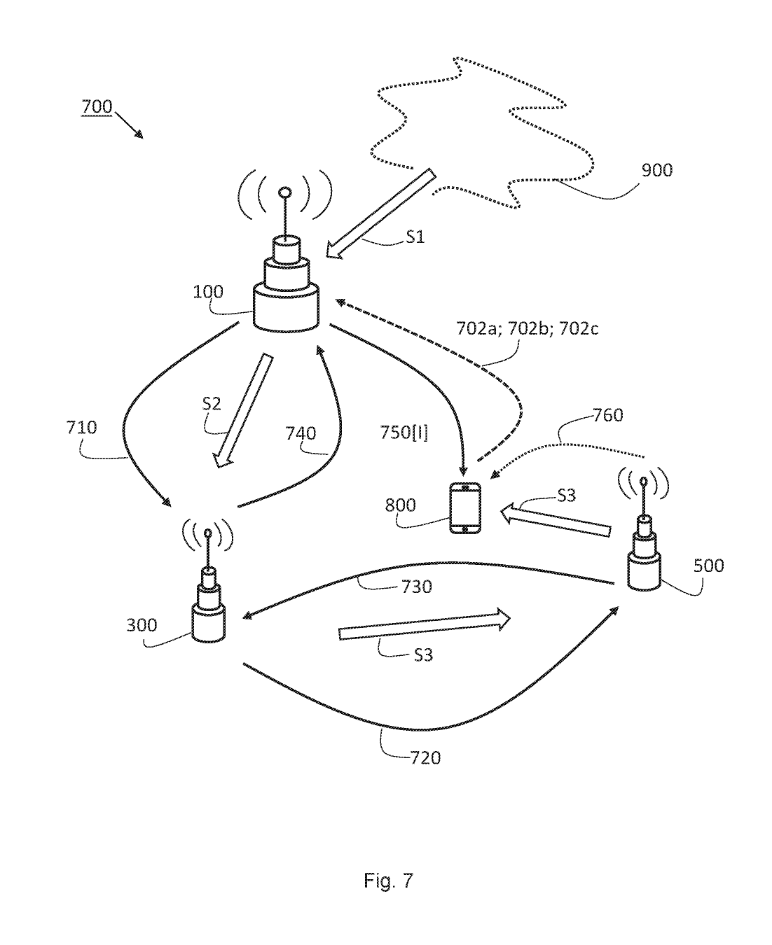

With reference to FIGS. 1 and 7, the transceiver 102 of the first network node 100 is configured to receive a first Radio Resource Management (RRM) message 702a, a second RRM message 702b, and a third RRM message 702c from a user device 800 (the dashed arrow from the user device 800 to the first network node 100 in FIG. 7). The first RRM message 702a comprises a first RRM measurement report 704a associated with the first network node 100, the second RRM message 702b comprises a second RRM measurement report 704b associated with a second network node 300, and the third RRM message 702c comprises a third RRM measurement report 704c associated with a third network node 500. The meaning of “associated with” in respect of the RRM measurement reports is that the information carried by the RRM measurement report is related to a specific network node, e.g. comprises measurements or measurement information relating to this specific network node.

The processor 104 of the first network node 100 is configured to determine a first control message 710 based on the first RRM message 702a, the second RRM message 702b and the third RRM message 702c. The first control message 710 comprises the third RRM measurement report 704c and a data plane establishment request (DPER) between the user device 800 and the third network node 500. Further, the transceiver 102 of the first network node 100 is configured to transmit the first control message 710 to the second network node 300.

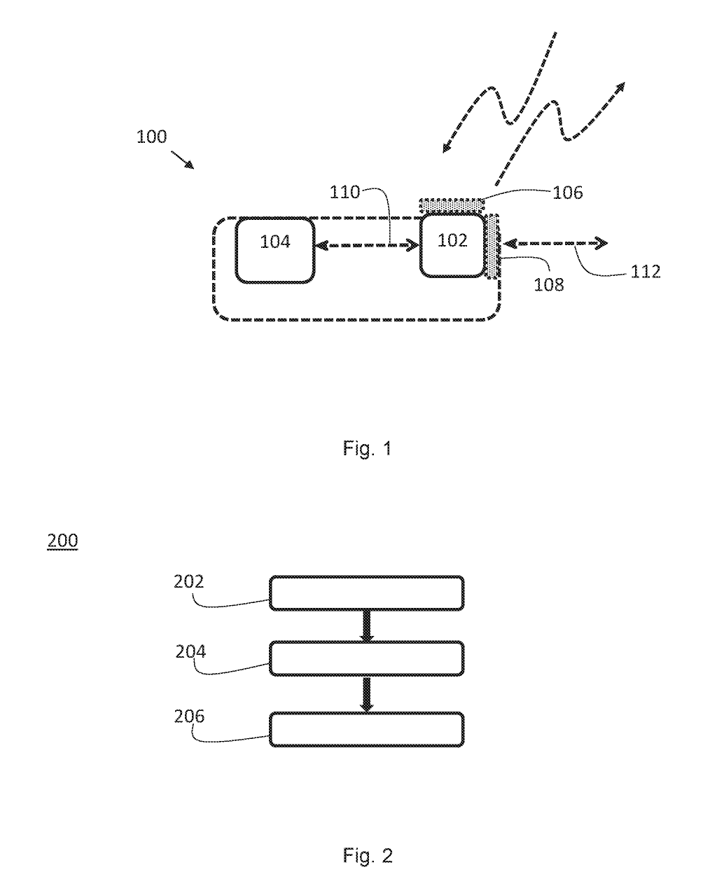

FIG. 2 shows a flow chart of a corresponding method 200 which may be executed in a first network node 100, such as the one shown in FIG. 1. The method 200 comprises receiving 202 a first RRM message 702a, a second RRM message 702b, and a third RRM message 702c from a user device 800. The first RRM message 702a comprises a first RRM measurement report 704a associated with the first network node 100, the second RRM message 702b comprises a second RRM measurement report 704b associated with a second network node 300, and the third RRM message 702c comprises a third RRM measurement report 704c associated with a third network node 500. The method 200 further comprises determining 204 a first control message 710 based on the first RRM message 702a, the second RRM message 702b and the third RRM message 702c. The first control message 710 comprises the third RRM measurement report 704c and a DPER between the user device 800 and the third network node 500. Further, the method 200 comprises transmitting 206 the first control message 710 to the second network node 300.

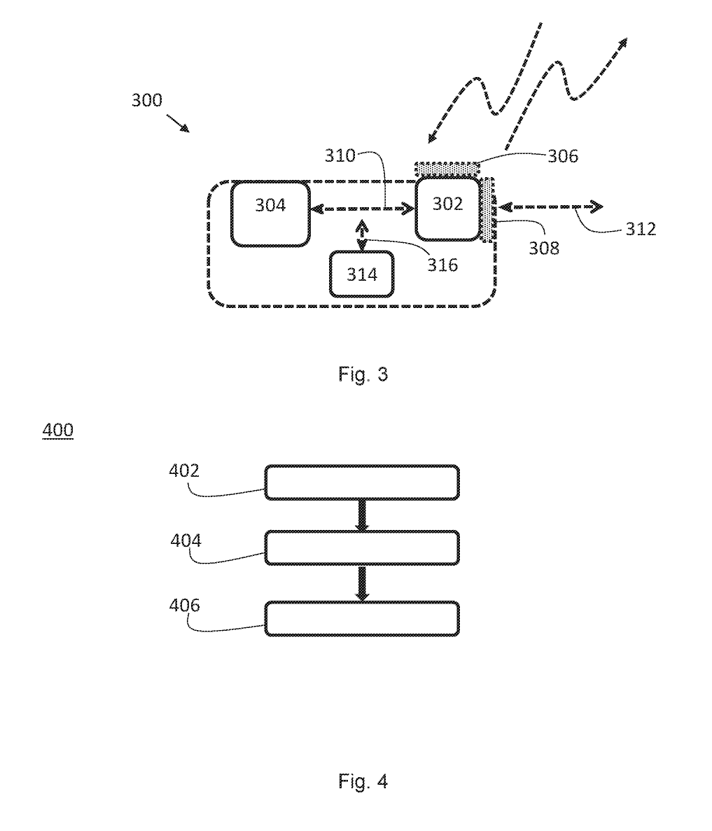

FIG. 3 shows a second network node 300 according to an embodiment of the disclosure. The second network node 300 comprises a transceiver 302 and a processor 304 which are communicably coupled to each other with communication means 310 known in the art. Further, the second network node 300 also comprises an antenna 306 and/or a modem 308 coupled with the transceiver 302. The antenna 306 is configured for wireless communications whilst the modem 308 is configured for wired communications via a wired communication interface 312 (e.g. a backhaul interface). The second network node 300 may also comprise a buffer 314 configured to store data packets for data transmissions. The buffer 314 is coupled to the processor 304 and the transceiver 302 with communication means 316. The processor 304 may be configured to control the buffer 314.

With reference to FIGS. 3 and 7, the transceiver 302 of the second network node 300 is configured to receive the above mentioned first control message 710 from the first network node 100. As already mentioned, the first control message 710 comprises the DPER between the user device 800 and the third network node 500 and the third RRM measurement report 704c associated with the user device 800 and the third network node 500. The processor 304 of the second network node 300 is configured to determine a second control message 720 comprising the DPER and the third RRM measurement report 704c if a communication interface exists between the second network node 300 and the third network node 500. The transceiver 302 of the second network node 300 is configured to transmit the second control message 720 to the third network node 500.

FIG. 4 shows a flow chart of a corresponding method 400 which may be executed in a second network node 300, such as the shown in FIG. 3. The method 400 comprises receiving 402 a first control message 710 from a first network node 100. The first control message 710 comprises a DPER between a user device 800 and a third network node 500 and a third RRM measurement report 704c associated with the user device 800 and the third network node 500. The method 400 further comprises determining 404 a second control message 720 comprising the DPER and the third RRM measurement report 704c if a communication interface exists between the second network node 300 and the third network node 500. The method 400 further comprises transmitting 406 the second control message 720 to the third network node 500.

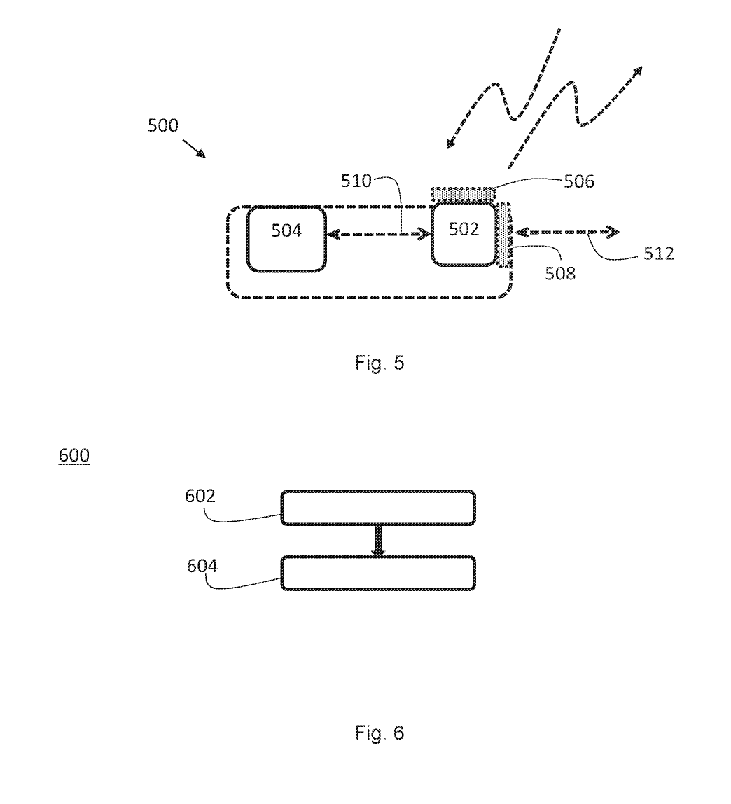

FIG. 5 shows a third network node 500 according to an embodiment of the disclosure. The third network node 500 comprises a transceiver 502 and a processor 504 which are communicably coupled to each other with communication means 510 known in the art. Further, the third network node 500 also comprises an antenna 506 and/or a modem 508 coupled with the transceiver 502. The antenna 506 is configured for wireless communications whilst the modem 508 is configured for wired communications via a wired communication interface 512.

With reference to FIGS. 5 and 7 the transceiver 502 of the third network node 500 is configured to receive the second control message 720 from the second network node 300. As mentioned above, the second control message 720 comprises the DPER between the user device 800 and the third network node 500 and the third RRM measurement report 704c associated with the user device 800 and the third network node 500. The transceiver 502 of the third network node 500 is further configured to establish a data plane connection to the user device 800 in response to the reception of the second control message 720 based on the third RRM measurement report 704c. The meaning of “establish a data plane connection” may mean to determine whether a data plane connection can be established with the user device 800 based on the second control message 720, and eventually to establish such a data plane connection. Furthermore, it should be understood that a control plane connection between the user device 800 and the third network node 500 does not need to be established.

FIG. 6 shows a flow chart of a corresponding method 600 which may be executed in a third network node 500, such as the shown in FIG. 5. The method 600 comprises receiving 602 a second control message 720 from a second network node 300. The second control message 720 comprises a DPER between a user device 800 and the third network node 500 and a third RRM measurement report 704c associated with the user device 800 and the third network node 500. The method 600 further comprises establishing 604 a data plane connection to the user device 800 in response to the reception of the second control message 720 based on the third RRM measurement report 704c.

A (radio) network node 100, 300, 500 can also be designated as a base station, e.g. a Radio Base Station (RBS), which in some networks may be referred to as transmitter, “eNB”, “eNodeB”, “NodeB” or “B node”, depending on the technology and terminology used. The network nodes may be of different classes such as e.g. macro eNodeB, home eNodeB or pico base station, based on transmission power and thereby also cell size. A network node can also be a Station (STA), which is any device that contains an IEEE 802.11-conformant Media Access Control (MAC) and Physical Layer (PHY) interface to the Wireless Medium (WM).

A user device 800, a UE, a mobile station, or wireless terminal and/or mobile terminal is enabled to communicate wirelessly in a wireless communication system, sometimes also referred to as a cellular radio system. The UE may further be referred to as mobile telephone, cellular telephone, computer tablet or laptop with wireless capability. The UEs in the present context may be, for example, portable, pocket-storable, hand-held, computer-comprised, or vehicle-mounted mobile devices, enabled to communicate voice and/or data, via the radio access network, with another entity, such as another receiver or a server. The UE can also be a Station (STA), which is any device that contains an IEEE 802.11-conformant Media Access Control (MAC) and Physical Layer (PHY) interface to the Wireless Medium (WM).

In the following disclosure further aspects and embodiments of the disclosure are described and illustrated. In this respect sometimes LTE and Wi-Fi terminology and expressions are used. It should however be noted that embodiments of the disclosure are not limited thereto. Further, the terms user device, UE, station and user device are hereafter used interchangeably. Similarly, access point (AP), network access point, access network node, WI-Fi AP, and LAA access point are hereafter used interchangeably.

FIG. 7 shows the interaction and interworking between a user device 800, a first network node 100, a second network node 300 and a third network node 500 according to aspects and embodiments of the disclosure. In FIG. 7 the user device has a data plane connection 760 to the third network node 500.

In one embodiment, the user device 800 has multiple connectivity in the wireless communications system 700 as illustrated in FIG. 7. In one particular case, the user device 800 uses 3 (or more) radios, each radio operating on a different radio frequency, to connect to an equal number of network nodes, cells or frequency carriers. In the example shown in FIG. 7, the user device 800 is wirelessly connected to a first network node 100 which provides an anchor for control plane via a RRC link using a first radio operating on a first radio frequency Fl and eventually a data plane connection (using the frequency F1 or another frequency). The user device 800 is further wirelessly connected with a second network node 300 providing a data plane connection using a second radio operating on a second radio frequency F2 in licensed spectrum or possibly on a third radio frequency F3 in a licensed or unlicensed frequency spectrum, e.g., WLAN channel or licensed assisted access LAA. Additionally, the user device 800 monitors at least a third network node 500 using a third radio operating on at least a fourth radio frequency F4 over licensed or unlicensed frequency spectrum for supporting data plane reconfiguration and mobility handling. In an example, a communication interface (e.g. backhaul interface), such as the LTE X2 interface, is assumed to exist at least between the first network node 100 and the second network node 300, and between the second network node 300 and the third network node 500. It is apparent to the skilled person that, without loss of generality, the frequency F2 can be the same as F4 and that the frequency F3 could be the same as F1.

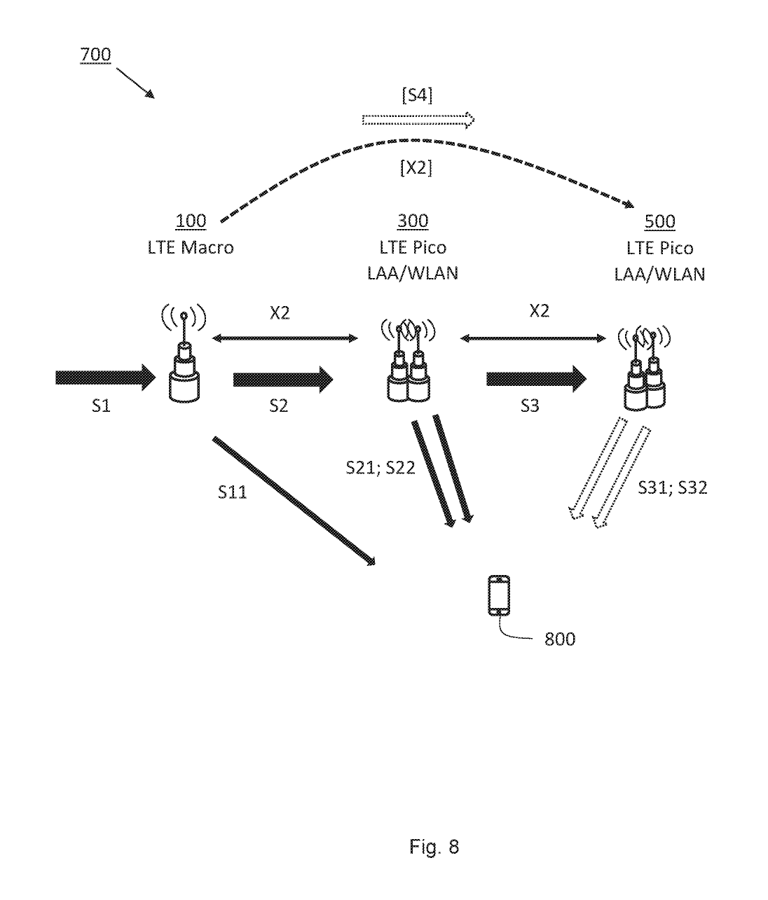

In one embodiment as disclosed in FIG. 8, the first network node 100 can be a master eNB of an LTE system (e.g., a macro eNB); the second network node 300 can be a secondary (source) cell (S-SeNB) of an LTE system with co-located WLAN access point or licensed assisted access (LAA) capability; and the third network node 500 can be a secondary (target) cell (T-SeNB) like the second network node 300, or an isolated access point of a different radio access technology, e.g., WLAN access point, mmWave access point, etc.

As already mentioned embodiments of the disclosure relate to a first network node 100. With reference to FIG. 7, to configure a new or an additional data plane connection from the third network node 500 to the user device 800 even when the first network node 100 and the third network node 500 do not share a communication interface (e.g., without a backhaul connection), the first network node 100 can transmit a first control message 710 to the second network node 300 comprising a DPER between the user device 800 and the third network node 300. The first control message 710 further comprises the third RRM measurement report 702c associated to the third network node 500.

The DPER may also comprise one or more of: the identity of the third network node 500, a request to establish a communication path to the third network node 500, and a request for data plane configuration for the user device 800 addressed to the third network node 500. In an alternative, the request for data plane configuration for the user device 800 addressed to the third network node 500 can be transmitted in a separate message by the first network node 100 once the second network node 300 has acknowledged the existence of a communication path with the third network node 500.

With reference to FIG. 7 the first network node 100 can be further configured to:
Receive from the second network node 300 a fourth control message 740 comprising a data plane establishment acknowledgement (DPEA) associated with the DPER.
Receive a first sequence of data packets S1 addressed for the user device 800 from a core network 900 of the communication system 700.
Forward a second sequence of data packets S2 to the second network node 300 in response to the reception of the fourth control message 740 and of the first sequence of data packets S1. The second sequence of data packets S2 comprises at least a part of the first sequence of data packets S1 received from the core network 900.

In an embodiment, the DPER further comprises a status report request (SRR) addressed to the third network node 500 for at least one of: a request of the available frequency bands or frequency carriers or RATs at the third network node 500.

Thereby, the first network node 100 can inquire a status report associated to two types of information associated to the third network node 500, namely: information related to the available resources and capabilities of the third network node 500; and information associated to the radio resources that the third network node 500 can make available to provide the required data plane connection for the user device 800 based, for instance, on the received RRM messages 702a, 702b or 702c.

Moreover, the DPER may further comprise at least one of: a request of traffic load report associated to the available frequency bands or frequency carriers or RATs; a request of interference level report in the available frequency bands or RATs; a request of recommended frequency bands or frequency carriers or RATs to establish a data plane connection with the user device; a request of the sustainable traffic load for the requested data plane connection; a request of the average amount of radio resource available for the requested data plane connection; and a request of the expected QoS or QoE for the requested data plane connection at the third network node 500.

Furthermore, the first network node 100 can be configured to:
Determine a fifth control message 750 comprising an instruction Ito establish a data plane connection with the third network node 500.
Transmit the fifth control message 750 to the user device 800 after reception of the fourth control message 740.

The instruction I, which is shown in FIG. 7, may comprises at least one of: an identity of the third network node 500; a frequency carrier or a RAT to be used for establishing the data plane connection to the third network node 500; and a data plane connection release command associated to an existing data plane connection which the user device 800 has.

Thereby, upon determining that a new data plane connection can be established for the user device 800, the first network node 100 can transmit control information to the user device 800 (either via a physical layer control channel or via higher layer RRC control signalling) comprising the instructions required to configure the new data plane connection.

In an embodiment, the first control message 710 further comprises a data plane establishment instruction (DPEI) which comprises a data split ratio of the second sequence of data packets S2 into a third sequence of data packets S3 addressed for the third network node 500. The third sequence of data of packets S3 comprises at least a part of the second sequence of data packets S2. Moreover, according to this embodiment, the first control message 710 may further comprise at least one of: an instruction addressed to the second network node 300 to further split the second sequence of data packets S2 based on the second RRM measurement report 704b and the third RRM measurement report 704c; an instruction addressed to the second network node 300 to forward all data packets of the second sequence of data packets S2 and remaining data packets in a buffer 314 addressed for user device 800 to the third network node 500; a minimum allocation of radio resources at the third network node 500 to support the data plane connection; and a preferred RAT to establish the requested data plane connection.

The data plane split ratio of the second sequence of data packets S2 into a third sequence of data packets S3 addressed for the third network node 500 regulates the amount of data packets (e.g., PDCP PDUs) that should be conveyed to the user device 800 through each of the second network node 300 and the third network node 500.

In one embodiment, the first network node 100 instructs the second network node 300 to forward to the third network node 500 all new data packets as well as all data packets in the buffer 314 of the second network node 300 addressed to the user device 800. This enables a fast release of the data plane between the second network node 300 and the user device 800 while the new data plane connection between the third network node 500 and the user device 800 delivers all data packets.

In another embodiment, the first network node 100 provides a second sequence of data packets S2 to the second network node 300 with an instruction addressed to the second network node 300 to further split the second sequence of data packets S2 into a at least two subsequences of data packets based on the second RRM measurement report 704b and the third RRM measurement report 704c, i.e.: at least a first subsequence S21 to be transmitted to the user device 800 by the second network node 300, and at least one subsequence to be transmitted to the user device 800 by the third network node 500 (i.e. the third sequence of data packets S3) as is shown in FIG. 8. Thus, the first sequence of data packets S1 associated with the data plane of user device 800 is first split at the first network node 100 (e.g., PDCP scheduler of the first network node 100) and subsequently split at the second network node 300 (e.g., PDCP scheduler of the second network node 300). Additionally, the first network node 100 could instruct the third network node 500 to use a minimum allocation of radio resources at the third network node 500 to support the data plane connection, and also use a preferred RAT to establish the requested data plane connection for the data plane connection with the user device 800.

The first RRM measurement report 702a, the second RRM measurement report 702b and the third RRM measurement report 702c may be reported by the user device 800 to the first network node 100 via higher layer RRC signalling. The first RRM message 702a, the second RRM message 702b, and the third RRM message 702c are in an alternative transmitted in separate messages from the same user device. In another alternative, the first RRM message 702a, the second RRM message 702b, and the third RRM message 702c are transmitted in one or two messages from the user device 800. In this respect the RRM message may be encapsulated in the message(s) from the user device 800. Each RRM measurement report 702a, 702b, 702c may e.g. comprise signal strength and channel quality indicators associated to a specific network node, to a set of time-frequency resources (such as a frequency carrier or a time-frequency resource block), and can additionally be associated with or identify a specific radio access technology, e.g. LTE in licensed spectrum, LTE in unlicensed spectrum, WLAN, etc. The time-frequency resources used for the RRM measurement reports 702a, 702b, 702c can further be associated to a licensed frequency band or to an unlicensed frequency band.

Based on the received RRM measurement reports 702a, 702b, 702c, and further based on mobility information, and quality of service (QoS) or quality of experience (QoE) requested from the user device 800, the first network node 100 may determine whether the third network node 500 should be configured to provide a data plane connection to the user device 800. In particular, the data plane connection from the third network node 500 could either replace a data plane connection from the first network node 100 or from the second network node 300 to the user device 800, or the data plane connection could be an additional data plane connection to provide better data rate, better QoS or better QoE via multi-connectivity or multi-stream aggregation techniques. Thereby, data plane connections from the first network node 100, the second network node 300 and the third network node 500 can be dynamically configured or scheduled for the user device 800 based on channel measurement and channel quality reports from the user device 800, as well being aggregated to provide higher data rates.

As mentioned before, embodiments of the disclosure also relate to a second network node 300. Upon receiving the DPER from the first network node 100, the second network node 300 can determine whether a communication interface exists with the network node 500 whose identity is indicated in the received DPER message. In one example, the communication interface can comprise a backhaul link (either wireless or wired) between the second network node 300 and the third network node 500 (e.g., the LTE X2 interface). If such communication interface exists, the second network node 300 shall transmit to the third network node 500 a second control message 720 comprising the DPER for the user device 800 and the third RRM measurement report 702c associated with the user device 800 and the third network node 500. A third control message 730 comprising a data plane establishment acknowledgement (DPEA) is expected to be received from the third network node 500 in response to the DPER. The second network node 300 is configured to forward the received DPEA to the first network node 100 in order to rapidly establish a new data plane connection with the user device 800 and enable to forward data for the user device 800 to the third network node 500.

Therefore, with reference to FIG. 7 the second network node 300 can be configured to:
Receive a third control message 730 from the third network node 500. The third control message 730 comprising a DPEA associated with the DPER.
Determine a fourth control message 740 comprising the DPEA in response to the reception of the third control message 730.
Transmit the fourth control message 740 (including the DPEA) to the first network node 100.

The DPEA message (positively) acknowledges (ACK) or refuses (NACK) the possibility to establish the requested data plane connection between the third network node 500 and the user device 800. When forwarded to the first network node 100 it further implicitly acknowledges to the first network node 100 the existence of a communication path between the second network node 300 and the third network node 500 (as otherwise the second network node 300 could not have received the DPEA from the third network node 500).

Furthermore, the DPEA may comprise a status report request response (SRRR) associated to the third network node 500 for at least one of: available frequency bands or frequency carriers or RATs at the third network node 500. The first control message 710 may in this embodiment further comprise a data plane establishment instruction (DPEI) comprising a preferred RAT to establish the requested data plane connection at the third network node 500.

The SRRR may further comprise at least one of: a traffic load report associated to the available frequency bands or frequency carriers or RATs; an interference level report in the available frequency bands or RATs; a report of recommended frequency bands or frequency carriers or RATs to establish a data plane connection with the user device; a report of the sustainable traffic load for the requested data plane connection; a report of the average amount of radio resource available for the requested data plane connection; and a report of the expected QoS or QoE for the requested data plane connection.

Furthermore, the second network node 300 can be configured to:
Receive a second sequence of data packets S2 addressed for the user device 800 from the first network node 100 in response to the transmission of the fourth control message 740.
Forward a third sequence of data packets S3 to the third network node 500. The third sequence of data packets S3 comprising at least a part of the second sequence of data packets S2.

According to the embodiment when the second network node 300 receives the second sequence of data packets S2, the first control message 710 may further comprise a DPEI comprising a data split ratio of the second sequence of data packets S2 into a third sequence of data packets S3 addressed for the third network node 500. In this case the second network node 300 is configured to determine the third sequence of data of packets S3 based on the data split ratio received in the DPEI.

According to the embodiment when the second network node 300 receives the second sequence of data packets S2, the first control message 710 may further comprise a DPEI comprising an instruction addressed to the second network node 300 to further split the second sequence of data packets S2 based on the second RRM measurement report 704b and the third RRM measurement report 704c. In this case the second network node 300 is configured to determine the third sequence of data packets S3 based on the second RRM measurement report 704b and the third RRM measurement report 704c.

According to the embodiment when the second network node 300 receives the second sequence of data packets S2, the first control message 710 may further comprise a DPEI indicating a minimum allocation of radio resources at the third network node 500 to support the data plane connection, or a preferred RAT to establish the requested data plane connection. In this case the second network node 300 is configured to determine the second control message 720 to further comprise the DPEI.

According to the embodiment when the second network node 300 receives the second sequence of data packets S2, the second network node 300 may be configured to forward all data packets of the second sequence of data packets S2 and remaining data packets in the buffer 314 addressed for the user device 800 to the third network node 500. Thereafter, the second network node 300 releases the data plane connection with the user device 800 after having forwarded all data packets of the second sequence of data packets S2 and of the buffer 314 to the third network node 500.

In this embodiment the first control message 710 further comprises a DPEI comprising an instruction for the second network node 300 to forward all data packets of the second sequence of data packets S2 and remaining data packets in the buffer 314 addressed for user device 800 to the third network node 500. This triggers the second network node 300 to empty the buffer 314 as described above.

In alternative, the second network node 300 may determine to forward to the third network node 500 all the remaining data packets in the buffer 314 and all new data packets received from the first network node 100 for the data plane connection of the user device 800 without receiving a corresponding DPEI from the first network node 100. This embodiment has the advantage of reducing data packet re-ordering at the user device 800 since the remaining data packets in the buffer of the second network node 300 are directly transmitted to the user device 800.

It should be noted that the SRR associated to radio resourced of the third network node 500 or the DPEI for forwarding data packets to the third network node 500 could in an alternative be transmitted by the first network node 100 either as part of the first control message 710 or in a separate message upon receiving from the second network node 300 the fourth control message 740 comprising an acknowledgement that a communication path to the third network node 500 exists or an acknowledgement that the third network node 500 can establish a data plane link with the user device 800 as part of the data plane establishment acknowledgement DPEA.

As mentioned before, embodiments of the disclosure also relate to a third network node 500. Based on the DPER from the second network node 300, the third network node 500 may determine whether the requested data plane for the user device 800 can be provided. Additionally, QoS and QoE requirements for the user device 800, availability of resources at the third network node 500, traffic load condition at the third network node 500 and interference conditions can be considered to determine whether a data plane connection can be provided to the user device 800.

The third network node 500 can further determine the best radio frequency or radio access technology to be used to provide the requested data plane connection to the user device 800, the average number of resources that can be used for the user data plane connection, such as average number of resource blocks (or resource blocks group) for an LTE carrier, average number for transmission time intervals wherein the user device 800 can be scheduled, average transmission time available for the user device 800 to in a WLAN carrier etc. The third network node 500 is then configured to transmit to the second network node 300 a third control message 730 comprising a DPEA for the requested data plane connection for the user device 800 comprising at least a positive or negative acknowledgement.

With reference to FIG. 7, the third network node 500 can be configured to:

Determine a third control message 730 comprising a (positive) DPEA after the establishment of the data plane connection to the user device 800.

Transmit the third control message 730 to the second control node 300.

The DPER may further comprise a SRR addressed to the third network node 500 for at least one of: a request of available frequency bands or frequency carriers or RATs at the third network node 500. In response to the reception of the SRR, or even without receiving the SRR, the third network node may include into the DPEA a SRRR for at least one of: available frequency bands or frequency carriers or RATs at the third network node 500.

The DPER may further comprise at least one of: a request of traffic load report associated to the available frequency bands or frequency carriers or RATs; a request of interference level report in available frequency bands or the RATs; a request of recommended frequency bands or frequency carriers or RATs to establish a data plane connection with the user device; a request of the sustainable traffic load for the requested data plane connection; a request of the average amount of radio resource available for the requested data plane connection; and a request of the expected QoS or QoE for the requested data plane connection. The SRRR may further comprise at least one of: available frequency bands or frequency carriers or RATs at the third network node 500; a report of traffic load report associated to the available frequency bands or frequency carriers or RATs; a report of interference level report in the available frequency bands or RATs; a report of recommended frequency bands or frequency carriers or RATs to establish a data plane connection with the user device; a report of the sustainable traffic load for the requested data plane connection; a report of the average amount of radio resource available for the requested data plane connection; and a report of the expected QoS or QoE for the requested data plane connection.

It should be noted that the SRRR could alternatively be transmitted by the third network node 500 either as part of the third control message 730 or in a separate message. It should be noted that the SRRR associated to the third network node 500 could be relayed by the second network node 300 either as part of the fourth control message 740 or in a separate control message.

Furthermore, the third network node 500 can be further configured to:
Receive a third sequence of data packets S3 from the second network node 300 in response to the transmission of the DPEA.
Transmit the third sequence of data packets S3 to the user device 800 via the established data plane connection.

In the embodiment when the third network node 500 receives the third sequence of data packets S3, the second control message 720 further comprises a DPEI between the user device 800 and the third network node 500. In this case the third network node 500 establishes a data plane connection to the user device 800 based on the DPEI. The DPEI may comprise instructions associated to at least one of: a minimum allocation of radio resources at the third network node 500 to support the requested data plane connection; a preferred RAT to establish the requested data plane connection; and a preferred frequency band to establish the requested data plane connection;

In the following disclosure further aspects of data split architectures according to embodiments of the disclosure are described. The data split architectures may be divided into two major data split architectures, i.e. data split architecture 1 and data split architecture 2 for a wireless communication system 700 which both are illustrated in FIG. 8.

In a first data split architecture and with reference to FIG. 8, a first packet-by-packet route selection for different data plane connections with the user device 800 is performed by the first network node 100 defining one, two or more data packet routes and the associated ratio of data flow splitting.

The first network node 100 is configured to receive a first sequence of data packets S1 addressed for the user device 800 from the core network 900 (not shown in FIG. 8). The first network node 100 is in this example a LTE macro node. The second network node 300 in FIG. 8 comprises of two or more co-located network nodes, i.e. a LTE pico node and a LAA/WLAN node. Also the third network node 500 in FIG. 8 comprises of two or more co-located network nodes, i.e. a LTE pico node and a LAA/WLAN node. Generally, the second network node 300 and/or the third network node 500 comprises co-located radio cellular cells over one licensed frequency carrier and at least one unlicensed frequency carrier (meaning in same physical box or connected by interface with latency <1 ms). The licensed frequency carrier can be an LTE frequency, while the unlicensed frequency carrier can be either a WLAN carrier or an LTE carrier used for licensed assisted access (LLA). In this case, RRM measurement reports associated with an unlicensed frequency carrier are signalled by the user device 800 over a licensed frequency carrier to the anchor network node (the MeNB) which in this case is the first network node 100. Further, the RRC measurement reports are further forwarded from the first network node 100 to a co-located LTE pico and WLAN node, with the RRC signalling RRC signalling carrying WLAN measurements. Additionally, if instructed by the first network node 100, the second network node 300 further forwards the RRM measurement report carrying WLAN measurements are further forwarded to the third network node 500.

The first network node 100 is connected to the second network node 300 via a first communication interface in FIG. 8 (e.g., a X2 interface in this example). The second network node 300 is connected to the third network node 500 via a second communication interface in FIG. 8 (e.g., a X2 interface in this example). However, the first network node 100 and the third network node 500 are not connected to each other by a communication interface in data split architecture 1. Furthermore, the user device 800 has a RRC connection to the first network node 100. Moreover, the user device 800 has also three downlink data plane connections; one downlink data plane connection to the first network node 100, and one downlink data plane connection each to the LTE pico node and LAA/WLAN node of the second network node 300, respectively.

A first sequence of data packets S11 is transmitted to the user device 800 by the first network node 100 using a first radio operating on a first frequency F1. The sequence of data packets S11 is a subsequence of the first sequence S1. Furthermore, the remaining packets of the first sequence S1 are transmitted by the first network node 100 to the second network node 300 as second sequence of data packets S2.

The second sequence of data packets S2 addressed for the user device 800 is transmitted through the second network node 300 and/or the third network node 500. A first subsequence S21 of the second sequence S2 can be transmitted to the user device 800 by the second network node 300 using a second radio operating on a second frequency F2. A second subsequence S22 of the second sequence S2 can be transmitted to the user device 800 by the second network node 300 using a third radio operating on a third frequency F3. Furthermore, the remaining packets of the second sequence S2 are transmitted by the second network node 300 to the third network node 500 as third sequence of data packets S3.

In other words, the third sequence of data packets S3 which is a subsequence of the second sequence of data packets S2 in this case is forwarded by the second network node 300 to the third network node 500. The third sequence of data packets S3 can be transmitted to the user device 800 by the third network node 500 using at least a third radio operating on a forth frequency F4. It should be noted that the third network node 500 can further determine to split the third sequence of data packets S3 into more than one subsequence to be transmitted to the user device 800 using different radio frequencies. In FIG. 8 it is illustrated how the third network node 500 splits the third sequence into subsequences S31 and S32.

The further data plane split of the second sequence of data packets S2 into at least two subsequences S21, S22 and the associated splitting ratio between subsequences can be determined either by the first network node 100 or by the second network node 300 based on RRM measurement reports from the user device 800.

Additionally, when the third sequence of data packets S3 is forwarded by the second network node 300 to the third network node 500, a further split of said third sequence of data packets S3 into at least two subsequences S31, S32 and the associated splitting ratio between subsequences of data packets can be determined either by the first network node 100, the second network node 300 or the third network node 500. In particular, the third network node 500 may perform a further split into two or more subsequences of data packets S31, S31 based on the received RRM measurement report 704c associated to the user device 800 if more than two frequencies are available at the third network node 500 for communicating with the user device 800. Thereby, control plane instructions can be relayed from the first network node 100 to the second network node 300 and to the third network node 500 so as to determine the correct packet-by-packet split ratio for different data plane connections with the user device 800.

One advantage of the first data split architecture is to enable the first network node 100 to efficiently split the data flow addressed to the user device 800 between multiple data plane connections, in order to provide the user device 800 with the required QoS and QoE. In addition, the first data split architecture enables the first network node 100 to efficiently establish and release multiple data plane connections for the user device 800 and the correct amount of data packets to be carried by each data plane connection to reduce latency, packet reordering at the user device 800, as well as to enable multi stream aggregation and higher data rates at the user device 800.

In a second data split architecture and with reference to FIG. 8, the first network node 100 has a communication interface, such as a X2 LTE interface, with both the second network node 300 and the third network node 500, respectively. The communication interface between the first network node 100 and the third network node 500 is illustrated with the curved dashed arrow between said network nodes.

Thus, the signalling exchange and the content of the control messages exchanged between the first network node 100 and the second network node 300 and the third network node 500 is different compared to the previously described first data split architecture.

In particular, the first control message 710 transmitted from the first network node 100 to the second network node 300 may comprise:
An address of the third network node 500 and a request to establish a communication path to the third network node 500; or
A set of instruction for data plane forwarding.

The third control message 730 transmitted from the first network node 100 to the third network node 500 in this particular case may comprise:
A third RRM measurement report 702c associated with the user device 800 and the third network node 500, and a request for data plane configuration for user device 800 addressed to the third network node 500; or
A request of a radio resource status report for the third network node 500.

The request of a radio resource status report for the third network node 500 and a set of instruction for data plane forwarding are according to previously described embodiments.

In addition, the third control message 730 is now transmitted from the third network node 500 directly to the first network node 100 (and not via the second network node 300), within the content according to previous embodiments the fourth control message 740 transmitted from the second network node 300 to the first network node 100 only comprises an acknowledgement of whether a communication interface to the third network node 500 exists.

An advantage of the second data split architecture is that data packet latency can be reduced, since new data packets associated to the user data plane being directly forwarded from the first network node 100 to the third network node 500. Furthermore, the second data split architecture has the benefit of enabling direct forwarding from the second network node 300 to the third network node 500 of the remaining data packets in the buffer 314 of the second network node 300 associated to the user device's data plane connection when the data plane connection is released from the second network node 300. Finally, the second data split architecture has the additional advantage of enabling multiple data plane connectivity for the user device 800 and supporting multi-stream aggregation to obtain higher data rate and QoE.

Furthermore, any method according to the embodiments of the present invention may be implemented in a computer program, having code means, which when run by processing means causes the processing means to execute the steps of the method. The computer program is included in a computer readable medium of a computer program product. The computer readable medium may comprise of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that the present network nodes 100, 300, 500 comprise the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the present solution.

Especially, the processors 104, 304, 504 of the first, second and third network nodes 100, 300, 500 may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Embodiment 1: a method (200) comprising:

receiving (202) a first Radio Resource Management, RRM, message (702a), a second RRM message (702b), and a third RRM message (702c) from a user device (800), the first RRM message (702a) comprising a first RRM measurement report (704a) associated with the first network node (100), the second RRM message (702b) comprising a second RRM measurement report (704b) associated with a second network node (300), and the third RRM message (702c) comprising a third RRM measurement report (704c) associated with a third network node (500);

determining (204) a first control message (710) based on the first RRM message (702a), the second RRM message (702b) and the third RRM message (702c), the first control message (710) comprising the third RRM measurement report (704c) and a data plane establishment request (DPER) between the user device (800) and the third network node (500);

transmitting (206) the first control message (710) to the second network node (300).

Embodiment 2: a method (400) comprising:

receiving (402) a first control message (710) from a first network node (100), the first control message (710) comprising a data plane establishment request (DPER) between a user device (800) and a third network node (500) and a third Radio Resource Management, RRM, measurement report (704c) associated with the user device (800) and the third network node (500);

determining (404) a second control message (720) comprising the data plane establishment request (DPER) and the third RRM measurement report (704c) if a communication interface exists between the second network node (300) and the third network node (500);

transmitting (406) the second control message (720) to the third network node (500).

Embodiment 3: a method (600) comprising:

receiving (602) a second control message (720) from a second network node (300), the second control message (720) comprising a data plane establishment request (DPER) between a user device (800) and the third network node (500) and a third Radio Resource Management, RRM, measurement report (704c) associated with the user device (800) and the third network node (500);

establishing (604) a data plane connection to the user device (800) in response to the reception of the second control message (720) based on the third RRM measurement report (704c).

Embodiment 4: a computer program with a program code for performing a method according to embodiment 1 to 3 when the computer program runs on a computer.

Finally, it should be understood that the disclosure is not limited to the embodiments described above, but also relates to and incorporates all embodiments within the scope of the appended independent claims.

What is claimed is:

1. First network node for a wireless communication system, the first network node comprising
a transceiver configured to
receive a first Radio Resource Management, RRM, message, a second RRM message, and a third RRM message from a user device, the first RRM message comprising a first RRM measurement report associated with the first network node, the second RRM message comprising a second RRM measurement report associated with a second network node, and the third RRM message comprising a third RRM measurement report associated with a third network node;
a processor configured to
determine a first control message based on the first RRM message, the second RRM message and the third RRM message, the first control message comprising the third RRM measurement report and a data plane establishment request (DPER) between the user device and the third network node;
wherein the transceiver is configured to
transmit the first control message to the second network node.

2. First network node according to claim 1, wherein the transceiver is configured to
receive a fourth control message from the second network node, the fourth control message comprising a data plane establishment acknowledgment (DPEA) associated with the data plane establishment request (DPER),
receive a first sequence of data packets (S1) addressed for the user device from a core network,
forward a second sequence of data packets (S2) to the second network node in response to the reception of the fourth control message, the second sequence of data packets (S2) comprising at least a part of the first sequence of data packets (S1).

3. First network node according to claim 2, wherein the processor is configured to
determine a fifth control message comprising an instruction (I) to establish a data plane connection with the third network node,
wherein the transceiver is configured to
transmit the fifth control message to the user device after reception of the fourth control message.

4. First network node according to claims 1, wherein the data plane establishment request (DPER) further comprises a status report request (SRR) addressed to the third network node (500) for at least one of: a request of the available frequency bands or frequency carriers or Radio Access Technologies, RATs at the third network node.

5. First network node according to claim 1, wherein the first control message further comprises a data plane establishment instruction (DPEI) comprising a data split ratio of a second sequence of data packets (S2) into a third sequence of data packets (S3) addressed for the third network node, wherein the third sequence of data of packets (S3) comprises at least a part of the second sequence of data packets (S2).

6. Second network node for a wireless communication system, the second network node comprising
a transceiver configured to
receive a first control message from a first network node, the first control message comprising a data plane establishment request (DPER) between a user device and a third network node and a third Radio Resource Management, RRM, measurement report associated with the user device and the third network node;
a processor configured to
determine a second control message comprising the data plane establishment request (DPER) and the third RRM measurement report if a communication interface exists between the second network node and the third network node;
wherein the transceiver is configured to
transmit the second control message to the third network node.

7. Second network node according to claim 6, wherein the data plane establishment request (DPER) further comprises a status report request (SRR) addressed to the third network node for at least one of: a request of the available frequency bands or frequency carriers or RATs of the third network node.

8. Second network node according to claim 6, wherein the transceiver is configured to
receive a third control message from the third network node, the third control message comprising a data plane establishment acknowledgment (DPEA) associated with the data plane establishment request (DPER),
wherein the processor is configured to
determine a fourth control message comprising the data plane establishment acknowledgment (DPEA) in response to the reception of the third control message,
wherein the transceiver is configured to
transmit the fourth control message to the first network node.

9. Second network node according to claim 8, wherein the data plane establishment acknowledgment (DPEA) comprises a status report request response (SRRR) associated to the third network node for at least one of: available frequency bands or frequency carriers or RATs at the third network node.

10. Second network node according to claim 8, wherein the transceiver is configured to
receive a second sequence of data packets (S2) addressed for the user device from the first network node in response to the transmission of the fourth control message,
forward a third sequence of data packets (S3) to the third network node, the third sequence of data packets (S3) comprising at least a part of the second sequence of data packets (S2).

11. Second network node according to claim 10, wherein the first control message further comprises a data plane establishment instruction (DPEI) comprising an instruction for the second network node to forward all data packets of the second sequence of data packets (S2) and remaining data packets in a buffer addressed for user device to the third network node,
wherein the transceiver is configured to
forward all data packets of the second sequence of data packets (S2) and remaining data packets in a buffer addressed for the user device to the third network node,
release the data plane connection with the user device after having forwarded all data packets of the second sequence of data packets (S2) and of the buffer.

12. Third network node for a wireless communication system, the third network node comprising
a transceiver configured to
receive a second control message from a second network node, the second control message comprising a data plane establishment request (DPER) between a user device and the third network node and a third Radio Resource Management, RRM, measurement report associated with the user device and the third network node;
establish a data plane connection to the user device in response to the reception of the second control message based on the third RRM measurement report.

13. Third network node according to claim 12, wherein the third network node comprises a processor configured to
determine a third control message comprising a data plane establishment acknowledgment (DPEA) after the establishment of the data plane connection to the user device,
wherein the transceiver is configured to
transmit the third control message to the second control node.

14. Third network node according to claim 13, wherein the data plane establishment request (DPER) further comprises a status report request (SRR) addressed to the third network node for at least one of: a request of available frequency bands or frequency carriers or RATs at the third network node, and
wherein the data plane establishment acknowledgment (DPEA) further comprises a status report request response (SRRR) for at least one of: available frequency bands or frequency carriers or RATs at the third network node.

15. Third network node (500) according to claim 13, wherein the transceiver (502) is configured to
receive a third sequence of data packets (S3) from the second network node (300) in response to the transmission of the data plane establishment acknowledgment (DPEA),
transmit the third sequence of data packets (S3) to the user device (800) via the established data plane connection.
